(19) United States
(12) Patent Application Publication
(10) Pub. No.: US 2014/0352614 A1
(43) Pub. Date: Dec. 4, 2014

(54) GLUE SPRAYING SYSTEM WITH DETECTION DEVICE

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/067,955

(22) Filed: Oct. 31, 2013

(30) Foreign Application Priority Data
May 30, 2013 (TW) 102119124

(51) Int. Cl. B05B 12/00; C09J 5/00

(52) U.S. Cl. CPC B05B 12/004; C09J 5/00
USPC 118/708

(57) ABSTRACT

A glue spraying system includes a transmission device, a spurting device, a pressing device, a detection device, and a control module. The transmission device includes a front and a rear transmission wheels, a thin film is transmission from the front transmission wheel to the rear transmission wheel by the transmission device. The spurting device is positioned above the thin film, and is for spurting glue on the thin film. The pressing device is positioned at a side of the spurting device, and is for pressing the glue on a spraying area of the thin film. The detection device is configured for detecting whether or not the glue is sprayed on the blank area. The control module is connected to the transmission device and the detection device. When the first sensor detects the glue, the control module controls the transmission device to slow down a transmission speed.

### BACKGROUND

1. Technical Field

The present disclosure relates to glue spraying systems, and particularly to a glue spraying system preventing glue from overflowing on a thin film.

2. Description of Related Art

Glue spraying systems generally include a spurting device and a roller. The spurting device spurts glue on a thin film. The roller uniformly presses the glue onto the thin film to cause the glue to spread uniformly over the thin film. However, if a flowing speed of the glue spraying on the thin film is too fast, the glue will overflow from a spraying area to a blank area of the thin film, which degrades product quality.

Therefore, it is desirable to provide a glue spraying system, which can overcome the limitations described.

### BRIEF DESCRIPTION OF THE DRAWINGS

FIG. 1 is an isometric view of a glue spraying system in accordance with an exemplary embodiment.

FIG. 2 is an isometric view of a thin film sprayed on a glue of FIG. 1.

FIG. 3 is an isometric view of a detection device facing the thin film of FIG. 1.

### DETAILED DESCRIPTION

Embodiments of the disclosure will be described with reference to the drawings.

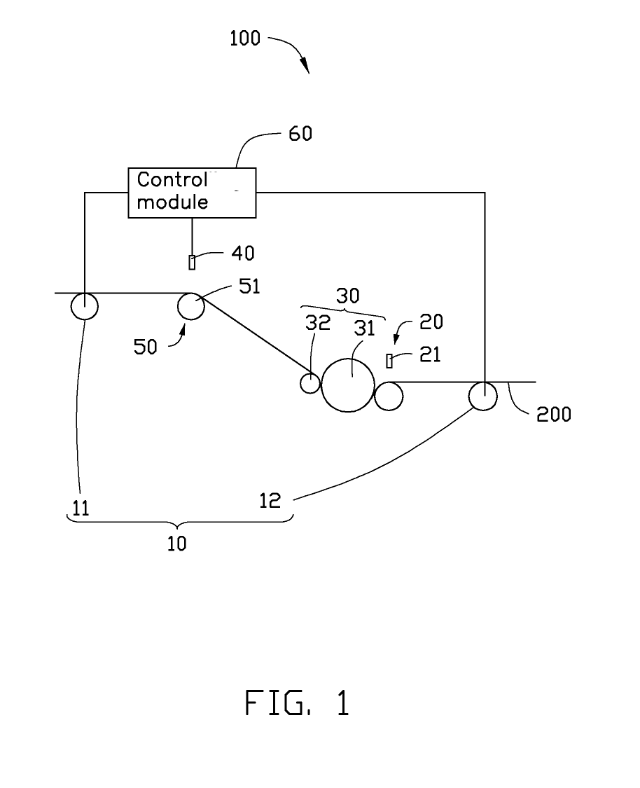

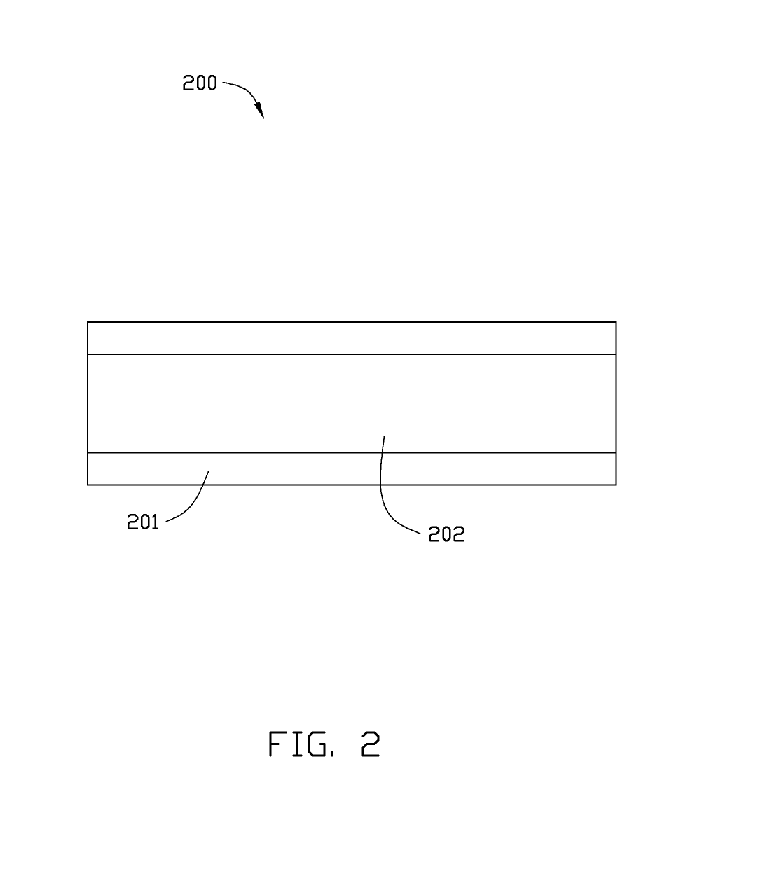

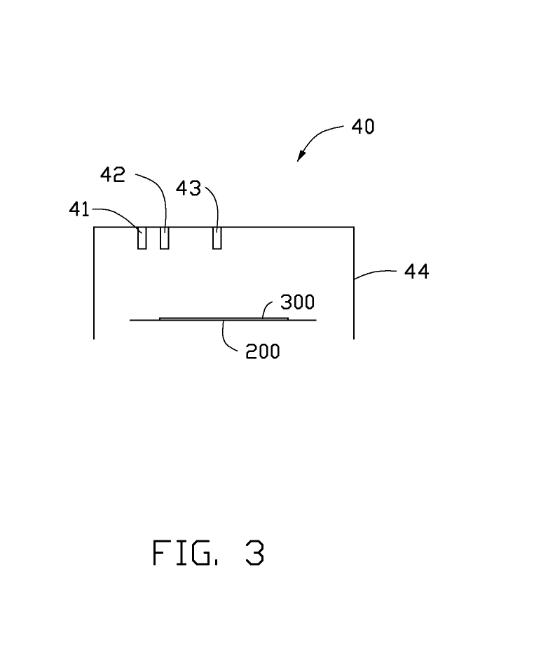

FIGS. 1-3 show a glue spraying system 100, according to an exemplary embodiment, which is used to spray glue 300 on a thin film 200. The thin film 200 includes a spraying area 201 and two blank areas 202 positioned at two opposite sides of the spraying area 201. The spraying area 201 is adjacent to a middle of the thin film 200, and the blank areas 202 are adjacent to two sides of the thin film 200. The glue 300 is sprayed on the spraying area 201.

The glue spraying system 100 includes a transmission device 10, a spurting device 20, a pressing device 30, a detection device 40, a guiding device 50, and a control module 60.

The transmission device 10 includes a rear transmission wheel 11 and a front transmission wheel 12. The thin film 200 is transmitted from the front transmission wheel 12 to the rear transmission wheel 11 by the transmission device 10 at a transmission speed. The transmission device 10 adjusts the transmission speed of the thin film 200 by adjusting a rotating speed of the front transmission wheel 12 and the rear transmission wheel 11. A rotating direction of the front transmission wheel 12 is the same as a rotating direction of the rear transmission wheel 11. In the embodiment, the front transmission wheel 12 and the rear transmission wheel 11 rotate along a counter clockwise direction. The spurting device 20, the pressing device 30, the detection device 40, the guiding device 50 are orderly positioned from the front transmission wheel 12 to the rear transmission wheel 11.

The spurting device 20 is positioned above the thin film 200, and is configured for spurting the glue 300 on the thin film 200. The spurting device 20 includes a spurting nozzle 21 and a pump body (not shown) communicating with the spurting nozzle 21. The glue 300 is received in the pump body. In the embodiment, the glue 300 is ultraviolet glue.

The pressing device 30 includes a molding roller 31 and two clamping rollers 32. The two clamping rollers 32 are positioned at two sides of the molding roller 31 along a transmission direction of the thin film 200. The thin film 200 intervenes between the molding roller 31 and the clamping rollers 32. A rotating direction of the molding roller 31 is different from a rotating direction of the clamping rollers 32. In the embodiment, the molding roller 31 rotates along a clockwise direction, and the clamping rollers 32 rotate along a counter clockwise direction. The spurting device 20 is positioned above the clamping roller 32 adjacent to the rear transmission wheel 11. The molding roller 31 defines a micro structure (not shown) on an outer cylindrical surface. A width of the thin film 200 is greater than a length of the molding roller 31, and a width of the spraying area 201 is slightly greater than a length of the molding roller 31.

The detection device 40 includes a first sensor 41, a second sensor 42, a third sensor 43, and a supporting frame 44. The first sensor 41, the second sensor 42, and the third sensor 43 are fixed on the supporting frame 44. The supporting frame 44 is positioned above the thin film 200. The first sensor 41 faces the blank area 202, generally adjacent to a center of the blank area 202. The second sensor 42 faces a junction of the spraying area 201 and the blank area 202. The third sensor 43 faces the spraying area 201, generally adjacent to a center of the spraying area 201. The first sensor 41, the second sensor 42, the third sensor 43 are configured for detecting whether or not the glue 200 is sprayed on the spraying area 201 and the blank area 202 of the thin film 200. In the embodiment, the first sensor 41, the second sensor 42, the third sensor 43 can be laser sensors or capacitive sensors.

The guiding device 50 includes a guiding wheel 51. The detection device 40 is positioned above the guiding wheel 51. The detection device 40 and the guiding wheel 51 face two opposite sides of the thin film 200, and the guiding wheel 51 contacts with a bottom side of the thin film 200.

The control module 60 is electrically connected to the transmission device 10 and the detection device 40. The control module 60 controls the rotation speed of the transmission device 10 according to a detection signal outputting from the detection device 40.

In use, the control module 60 controls the transmission device 10 to rotate at an initial transmission speed. The spurting device 20 spurts the glue 300 on the thin film 200. The pressing device 30 uniformly compresses the glue 300 on the spraying area 201 of the thin film 200. The micro structure of the molding roller 31 is transferred to the glue 300 sprayed on the spraying area 201.

The first sensor 41, the second sensor 42, and the third sensor 43 respectively detect whether or not the glue 200 is sprayed on the blank area 202, the junction of the spraying area 201 and the blank area 202, and the spraying area 201. When the third sensor 43 detects the glue 300, and the first sensor 41 and the second sensor 42 fail to detect the glue 300, the control module 60 controls the transmission device 10 to speed up the transmission speed. The rotation speed of the front transmission wheel 12 and the rear transmission wheel 11 is increased. When the second sensor 42 and the third sensor 43 detect the glue 300, and the first sensor 41 fails to detect the glue 300. The control module 60 controls the transmission device 10 to keep the transmission speed. When the first sensor 41, the second sensor 42, and the third sensor 43 detect the glue 300, the control module 60 controls the transmission device 10 to slow down the transmission speed. The rotation speed of the front transmission wheel 12 and the rear transmission wheel 11 is decreased.

When the transmission speed of the transmission device 10 is sped up, the glue 300 sprayed on the spraying area 201 flows quickly toward the junction of the spraying area 201 and the blank area 202. When the transmission speed of the transmission device 10 is slowed down, the glue 300 sprayed on the spraying area 201 decelerate flowing toward the junction of the spraying area 201 and the blank area 202.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A glue spraying system, comprising:
a transmission device comprising a front transmission wheel and a rear transmission wheel, the transmission device configured to transit a thin film from the front transmission wheel to the rear transmission wheel;
a spurting device positioned above the thin film and configured for spurting a glue on the thin film;
a pressing device positioned at a side of the spurting device facing away from the front transmission wheel, and configured for pressing the glue on a spraying area of the thin film;
a detection device comprising a first sensor facing a blank area of the thin film, the blank area positioned at a side of the spraying area; the detection device configured for detecting whether or not the glue is sprayed on the blank area; and
a control module connected to the transmission device and the detection device, wherein when the first sensor detects the glue, the control module controls the transmission device to slow down a transmitting speed.

2. The glue spraying system of claim 1, wherein a rotating direction of the front transmission wheel is the same as a rotating direction of the rear transmission wheel.

3. The glue spraying system of claim 1, wherein the pressing device comprises a molding roller and two clamping rollers; the two clamping rollers are positioned at two sides of the molding roller along a transmitting direction of the thin film.

4. The glue spraying system of claim 3, wherein the thin film is clamped between the molding roller and the clamping rollers; a rotating direction of the molding roller is different from a rotating direction of the clamping rollers.

5. The glue spraying system of claim 3, wherein the spurting device is positioned above one of the clamping rollers adjacent to the front transmission wheel.

6. The glue spraying system of claim 1, wherein the detection device comprises a second sensor facing a junction of the spraying area and the blank area and a third sensor facing the spraying area.

7. The glue spraying system of claim 6, wherein the second sensor and the third sensor respectively detects whether or not the glue is sprayed on the junction of the spraying area and the blank area, and the spraying area.

8. The glue spraying system of claim 7, wherein when the second sensor and the third sensor detect the glue and the first sensor fails to detect the glue, the control module controls the transmission device to keep the transmitting speed.

9. The glue spraying system of claim 7, wherein when the first sensor, the second sensor, and the third sensor detect the glue, the control module controls the transmission device to slow down the transmitting speed.
